(19) United States
(12) Patent Application Publication
(10) Pub. No.: US 2015/0023652 A1
(43) Pub. Date: Jan. 22, 2015

(54) UPDATING OF ADVERTISING CONTENT DURING PLAYBACK OF LOCALLY RECORDED CONTENT

(71) Applicant: Uniloc Luxembourg, S.A., Plano, TX (US)

(72) Inventor: Dono Harjanto, Irvine, CA (US)

(21) Appl. No.: 14/337,369

(22) Filed: Jul. 22, 2014

Related U.S. Application Data
(60) Provisional application No. 61/857,068, filed on Jul. 22, 2013.

(51) Int. Cl. H04N 21/234; G11B 27/029

(52) U.S. Cl. CPC H04N 21/23424; G11B 27/029
USPC 386/249

(57) ABSTRACT

A DVR parses advertising audiovisual content, i.e., commercials, from a received audiovisual signal during recording. The DVR stores only commercial-free content and replaces parsed commercials with their URLs for retrieval during playback. During playback, the DVR requests commercial audiovisual content to be played back in place of the parsed commercials using the stored URLs, determines whether the commercial is played back in its entirely at a normal rate (not skipped), logs whether the commercial was skipped, and periodically sends a log of playback of all commercials to the commercial server. As a result, the commercial server has a complete record of all impressions of commercials played back through the DVR.

This application claims priority to U.S. Provisional Application No. 61/857,068, which was filed Jul. 22, 2013 and which is fully incorporated herein by reference.

### BACKGROUND OF THE INVENTION

1. Field of the Invention

The present invention relates generally to multimedia systems for playback of recorded audiovisual content and, more particularly, methods of and systems for maintaining currency of advertising content embedded in locally recorded audiovisual content.

2. Description of the Related Art

The majority of funding of broadcast audiovisual content viewed in the world today comes from embedded advertising content commonly referred to as “commercials.” Generally, the cost of inclusion of such commercials in broadcast audiovisual content relates to the number of impressions, i.e., times the commercial will be viewed by individual people. For example, if 1,000,000 people see a given commercial three (3) times each on average, the commercial has 3,000,000 impressions.

Currently, there is no satisfactory way to determine how many impressions a given commercial has achieved. There are surveys conducted to coarsely estimate the number of display devices (such as televisions) that watch a number of broadcast shows. However, the proliferation of digital video recorders (DVRs) has temporally shifted much of the viewing of broadcast audiovisual content. As a result, attempts have been made to survey such temporally shifted viewing to more accurately ascertain popularity of broadcast shows and, as a result, impressions of various commercials.

DVRs pose a particularly difficult problem when counting impressions, because it is quite common for people to view content recorded on a local DVR multiple times. For example, if a viewer watches the same show three (3) times, each of the commercials embedded in that show will have three (3) impressions. Some small children enjoy repetition so much that they'll insist on watching the same show dozens, or even perhaps hundreds times. These multiple impressions of commercials embedded in a given show are not counted in surveys yet increase the value of the commercials.

In addition, viewers watching locally recorded content skip commercials by accelerating playback (fast forwarding) through the commercials. Such should not be considered a full impression of the skipped commercials. Some inattentive viewers may watch a few commercials during a commercial break before skipping the remainder of the commercials of the break. And, even skipped commercials show enough content, albeit at an accelerated rate, that the viewer recalls and understands the content of the commercial. It is believed that commercials with a high number of impressions to a given viewer are more likely to be skipped by that viewer.

What is needed is a way to accurately determine the number of impressions of advertising content that is recorded by and played back through a DVR, CD, or other local recording medium.

### SUMMARY OF THE INVENTION

In accordance with the present invention, a digital video recorder (DVR), while locally recording a received audiovisual signal, parses advertising audiovisual content, i.e., commercials, from the received audiovisual signal. The DVR stores only commercial-free content and replaces parsed commercials with universal resource locaters (URLs) of the commercials for retrieval during playback. During playback of the locally recorded audiovisual content, the DVR requests commercial audiovisual content to be played back in place of the parsed commercials using the stored commercial URLs. The commercial audiovisual content is received from a commercial server in response to the requests.

This provides two (2) primary advantages. First, the DVR can accurately keep track of the number of impressions of a given commercial. The DVR can detect skipping of a commercial by accelerated playback and can accurately report which commercials are skipped. Second, the commercial server can decide to stream a commercial other than the one requested by URL from the DVR, thereby maintaining currency and relevancy of commercials embedded in audiovisual content recorded locally by the DVR.

During recording of the received audiovisual signal, the DVR detects a commercial at a location within the received audiovisual signal. The received audiovisual signal includes meta data that flags the commercial as such—by identifying the locations at which commercial audiovisual content begins and ends in the received audiovisual signal—and includes an identifier by which the commercial can later be retrieved. Instead of capturing the commercial audiovisual content, the DVR stores the commercial identifier, which can be a URL, in association with data representing the location of the identified commercial in the received audiovisual signal.

During playback of the received audiovisual signal as locally recorded audiovisual signal, the DVR sends requests to a commercial server for commercials to be inserted into the locally recorded audiovisual signal using the stored commercial identifiers. The DVR inserts commercials received from the commercial server in response to the requests into the locally recorded audiovisual signal at the respective associated locations.

When a commercial is playing, the DVR determines whether the commercial is played back in its entirely at a normal playback rate. If so, the viewer did not skip the commercial by accelerating playback. The DVR logs the date and time and identifiers of the commercial and whether the commercial was skipped in whole or in part. The DVR periodically sends a log of playback of all commercials to the commercial server. As a result, the commercial server has a complete record of all impressions of commercials played back through the DVR.

### BRIEF DESCRIPTION OF THE DRAWINGS

Other systems, methods, features and advantages of the invention will be or will become apparent to one with skill in the art upon examination of the following FIG.s and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a number of devices that cooperate to track impressions of commercials in accordance with one embodiment of the present invention.

FIG. 2 is a block diagram of a commercial record representing a commercial that can be tracked in accordance with one embodiment of the present invention.

FIG. 3 is a logic flow diagram illustrating one embodiment according to the invention of a method by which a DVR of FIG. 1 records received audiovisual content and parses commercials therefrom.

FIG. 4 is a block diagram showing a combination of locally captured audiovisual content and commercial identifiers for subsequent playback in accordance with an embodiment of the present invention.

FIG. 5 is a logic flow diagram illustrating one embodiment according to the invention of a method by which a DVR of FIG. 1 plays locally recorded audiovisual content and detects playback and skipping of commercials.

FIG. 6 is a logic flow diagram illustrating one embodiment according to the invention of a method by which a DVR of FIG. 1 detects skipping of commercials.

FIG. 7 is a block diagram showing a log of commercials that represents playback and skipping of commercials.

FIG. 8 is a block diagram showing the DVR of FIG. 1 in greater detail.

FIG. 9 is a block diagram showing the commercial server of FIG. 1 in greater detail.

### DETAILED DESCRIPTION

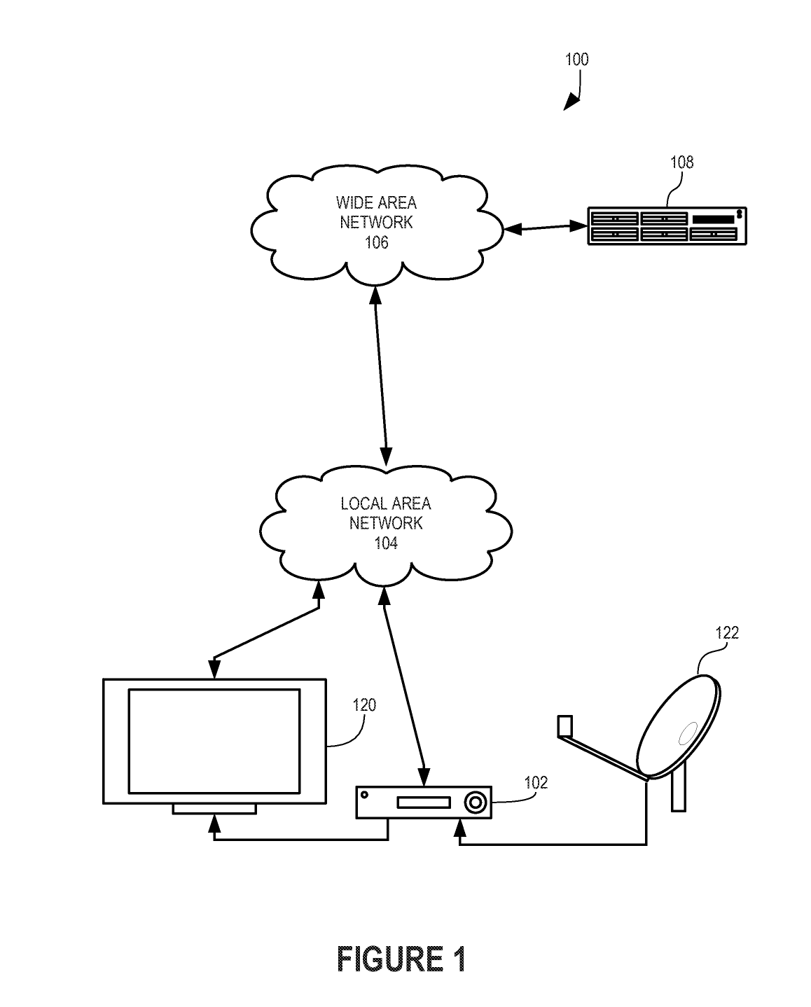

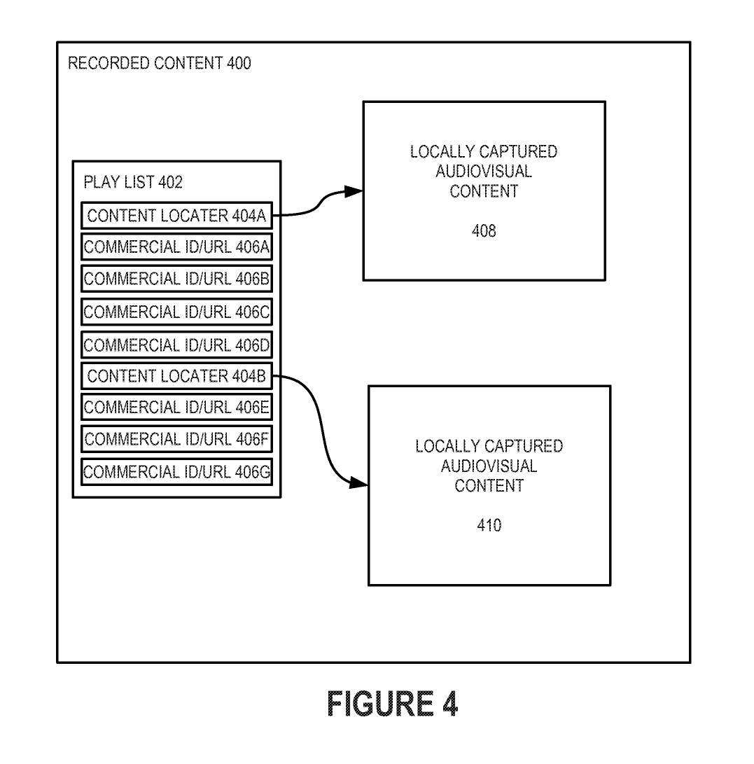

In accordance with the present invention, a digital video recorder (DVR) 102 (FIG. 1) parses advertising content, i.e., commercials, from broadcast audiovisual content, storing only commercial-free content 408 (FIG. 4) and 410 and replacing parsed commercials with universal resource locaters (URLs) of the commercials for retrieval during playback. As a result, a remotely located commercial server 108 (FIG. 1) streams commercials to DVR 102, and DVR 102 embeds the streamed commercials into playback of the locally recorded audiovisual content.

This provides two (2) primary advantages. First, DVR 102 can accurately keep track of the number of impressions of a given commercial. DVR 102 can detect skipping of a commercial by accelerated playback and can accurately report which commercials are skipped. Second, commercial server 108 can decide to stream a commercial other than the one requested by URL from DVR 102, thereby maintaining currency and relevancy of commercials embedded in audiovisual content recorded locally by DVR 102.

Diagram 100 shows DVR 102 and streaming server 108 connected to one another through a wide area network (WAN) 106, which is the Internet in this illustrative embodiment, and a local area network (LAN) 104. DVR 102 receives broadcast audiovisual content from a satellite (not shown) through a satellite dish 122 in a conventional manner. In alternative embodiment, DVR 102 can receive broadcast audiovisual content through any other known or available systems, including cable and over-the-air broadcasts for example. DVR 102 displays the received audiovisual content through a television 120 in a conventional manner. Some televisions available today can also receive streamed content through LAN 104 and WAN 106 and can be adapted to include local storage for recorded content and can therefore record and play back audiovisual content in the manner described herein in conjunction with DVR 102.

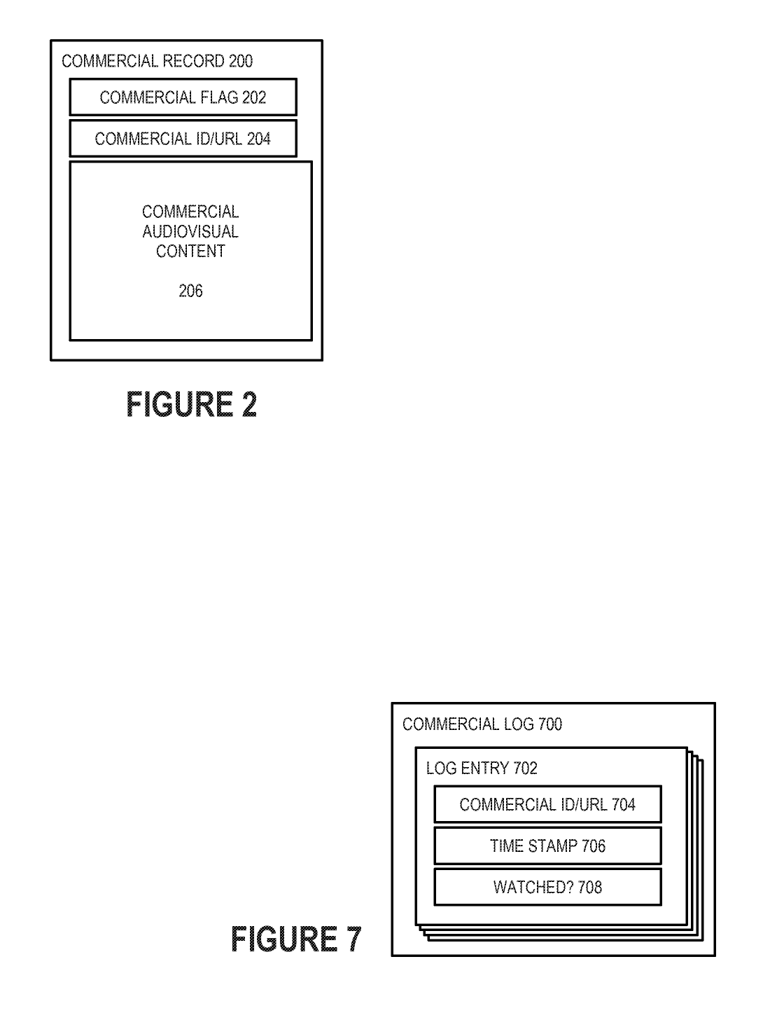

Within audiovisual content received through satellite dish 122, commercials are identified as such in a manner illustrated in FIG. 2. Commercial record 200 includes a commercial flag 202 that identifies the content as a commercial and a commercial identifier/URL 204 that uniquely identifies the subject commercial of commercial record 200. If all commercials are to be retrieved through a single commercial server 108, commercial ID/URL 204 can be any unique identifier recognized by commercial server 108. Using a conventional URL as commercial ID/URL 204 allows commercials to be distributed across multiple commercial servers.

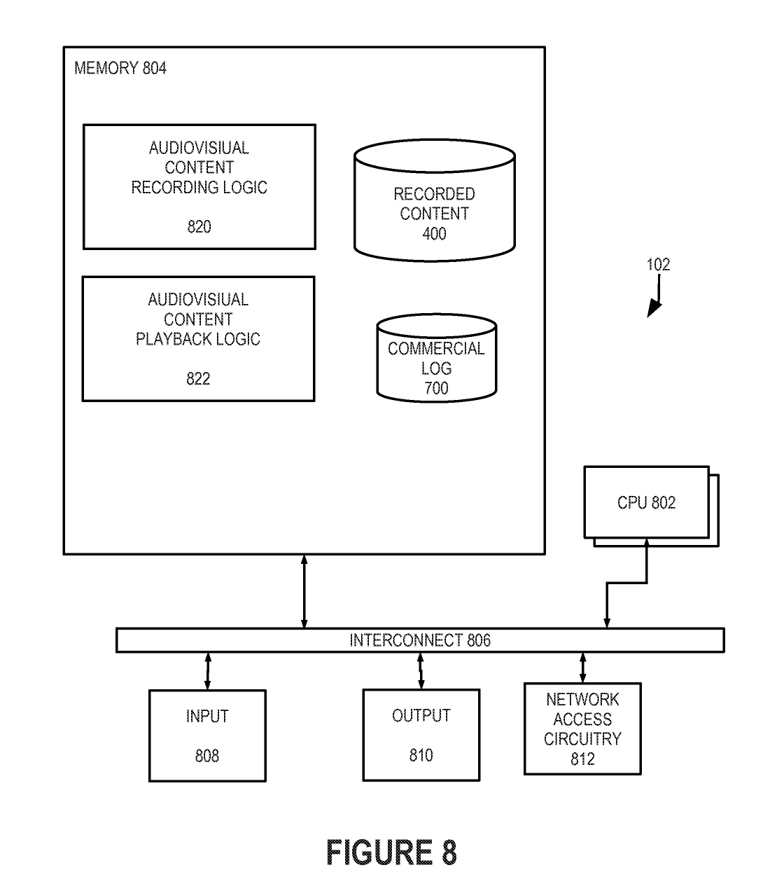

Commercial audiovisual content 206 is the audiovisual content to be displayed to the viewer as an impression. In this illustrative embodiment, commercial record 200 is in the form of an MPEG file and commercial flag 202 and commercial ID/URL 204 are embedded in the MPEG file as metadata that can be parsed and recognized by audiovisual content recording logic 820 (FIG. 8) of DVR 102. The various components of DVR 102 shown in FIG. 8 are described in greater detail below. In alternative embodiments, commercial audiovisual content 206 (FIG. 2) can be associated with commercial flag 202 and commercial ID/URL 204 using alternative techniques. For example, commercial audiovisual content 206 can be delivered according to the Real-time Transport Protocol (RTP), and commercial flag 202 and commercial ID/URL 204 can be delivered in association with commercial audiovisual content 206 according to the RTP Control Protocol (RTCP). RTP and RTCP are known and are not described in detail herein.

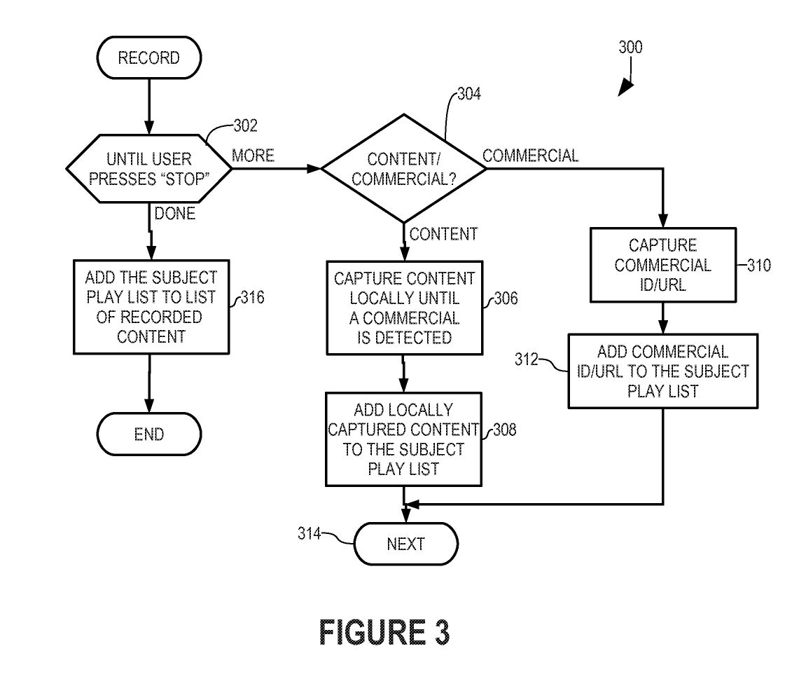

The manner in which audiovisual content recording logic 820 (FIG. 8) of DVR 102 records audiovisual content received through satellite dish 122 (FIG. 1) is illustrated by logic flow diagram 300 (FIG. 3). Loop step 302 and next step 314 define a loop in which DVR 102 processes the incoming audiovisual signal according to steps 304-312 until the user terminates recording, e.g., by pressing a STOP button on DVR 102 or a remote control thereof.

In test step 304, DVR 102 determines whether the currently received audiovisual content is a commercial. If not, processing transfers to step 306 in which DVR 102 captures the currently received audiovisual content until a commercial is detected. DVR 102 stores the currently received audiovisual content as locally captured audiovisual content 408 (FIG. 4). In step 308 (FIG. 3), DVR 102 adds a content locater 404A (FIG. 4) that points to locally captured audiovisual content 408 to a play list 402.

After step 308, processing by DVR 102 transfers through next step 314 to loop step 302 in which DVR 102 continues to process currently received audiovisual content according to steps 304-312.

If, in test step 306, DVR 102 determines that the currently received audiovisual content is a commercial, processing by DVR 102 transfers from test step 302 to step 310. In step 310, DVR 102 captures the commercial ID/URL of the currently received audiovisual content. In step 312, DVR 102 stores the captured commercial ID/URL in play list 402 (FIG. 4), e.g., as commercial ID/URL 406A.

After step 312, processing by DVR 102 transfers through next step 314 to loop step 302 in which DVR 102 continues to process currently received audiovisual content according to steps 304-312.

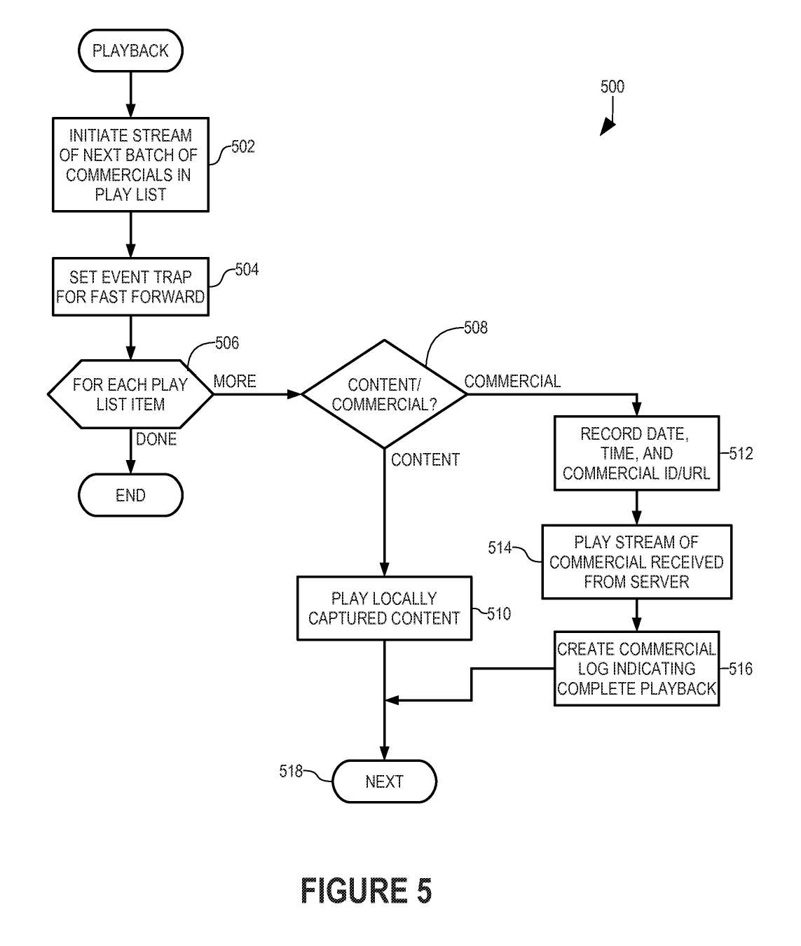

An example of a resulting play list of such recording by DVR 102 is shown as play list 402. In this illustrative example, the recorded audiovisual content included locally captured audiovisual content 408, followed by four (4) commercials identified by commercial ID/URLs 406A-D, followed by locally captured audiovisual content 410, followed by three (3) commercials identified by commercial ID/URLs 406E-G. Playback by DVR 102 of the audiovisual content represented by play list 402 is performed by audiovisual content playback logic 822 (FIG. 8) of DVR 102 and is illustrated by logic flow diagram 500 (FIG. 5).

In step 502, DVR 102 initiates streaming of the next batch of commercials from play list 402 (FIG. 4). Playback of streamed content is often initially delayed as an amount of content must be cached to provide seamless and continuous playback of the streamed content. Accordingly, DVR 102 initiates early streaming of commercial content to provide seamless and continuous playback of the content identified by play list 402. In this illustrative example, DVR 102 sends commercial ID/URLs 406A-D to commercial server 108 (FIG. 1) in step 502 (FIG. 5).

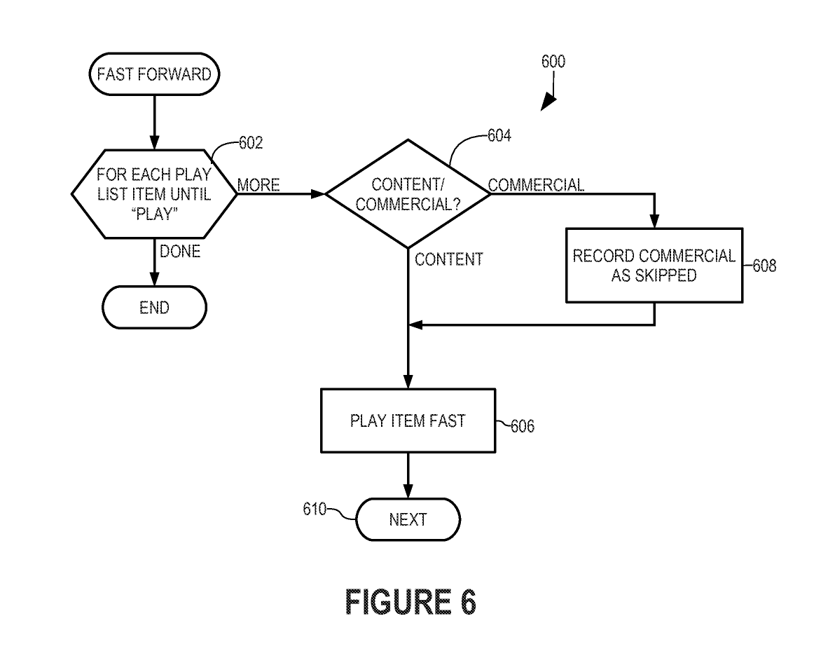

In step 504, DVR 102 sets an event trap to detect initiation of accelerated playback and, in such event, to perform the steps of logic flow diagram 600 (FIG. 6).

Loop step 506 (FIG. 5) and next step 518 define a loop in which DVR 102 processes each item of play list 402 (FIG. 4) according to steps 508-516. During each iteration of the loop of steps 506-518, the play list item currently processed by DVR 102 is sometimes referred to as “the subject play list item.”

In test step 508, DVR 102 determines whether the subject play list item is a commercial ID/URL. If not, processing transfers to step 510 in which DVR 102 plays the locally captured audiovisual content identified by the subject play list item. Conversely, the subject play list item is a commercial ID/URL, processing transfers to step 512.

In step 512, DVR 102 records the current date, current time, and the commercial ID/URL of the commercial record received from commercial server 108. It should be noted that, since commercial server 108 can decide to deliver commercials other than the requested commercials, the commercial ID/URL recorded in step 512 can differ from the corresponding one of commercial ID/URLs 406A-D (FIG. 4).

In step 514, DVR 102 plays the stream of audiovisual content received from commercial server 108. In step 516 at which point playback of the stream of audiovisual content received from commercial server 108 is complete, DVR 102 creates a commercial log entry indicating that the commercial of the subject play list item has been completely viewed.

After either step 510 or step 516, processing by DVR 102 transfers through next step 518 to loop step 506 and the next item of play list 402 (FIG. 4) is processed by DVR 102 according to the loop of steps 506-518. When all items of play list 402 have been processed according to the loop of steps 506-518, playback by DVR 102 completes.

As noted above, processing of the items of play list 402 switches to processing according to logic flow diagram 600 (FIG. 6) upon detection that the viewer has requested accelerated playback by pressing a “fast forward” button on DVR 102 or a remote control thereof. Loop step 602 and next step 610 define a loop in which DVR 102 processes each item of play list 402 (FIG. 4) according to steps 604-608, starting at the current playback position from playback at normal speed according to logic flow diagram 500 (FIG. 5). During each iteration of the loop of steps 602-610, the play list item currently processed by DVR 102 is sometimes referred to as “the subject play list item.” The loop of steps 602-610 is terminated by completion of playback of all items of play list 402 (FIG. 4) or by the viewer requesting a return to normal speed playback, in which case playback of the items of play list 402 resumes at normal speed according to logic flow diagram 500 (FIG. 5).

In test step 604 (FIG. 6), DVR 102 determines whether the subject play list item is a commercial ID/URL. If so, DVR 102 records the subject play list item as skipped in step 608. If DVR 102 has not already recorded the current date and time and the commercial ID/URL of the subject play list item as described in step 512 or created the commercial log entry in the manner described in step 516, DVR 102 does so in step 608.

After step 608, or from test step 604 if DVR 102 determines that the subject play list item is not a commercial ID/URL, DVR 102 plays the subject play list item at an accelerated rate in step 606. Upon completion of step 606, processing transfers through next step 610 to loop step 602 and the next item of play list 402 is processed by DVR 102 according to the loop of steps 602-610.

FIG. 7 shows an illustrative example of a number of commercial log entries 702 that collectively form a commercial log 700. Log entry 702 includes a commercial ID/URL 704 identifying a commercial that was played for the viewer. As noted above, the commercial that was played for the user might not be the one that was identified in play list 402 (FIG. 4). Time stamp 706 (FIG. 7) identifies the date and time at which the commercial identified by commercial ID/URL 704 was played. Watched flag 708 specifies whether the commercial was watched or skipped. In some embodiments, watched flag 708 can specify a length of a commercial played back at normal speed for commercials watched only partially at normal speed. Periodically, DVR 102 sends commercial log 700 to commercial server 108. Accordingly, commercial server 108 has a detailed account of impressions of commercials through DVR 102.

As noted above, DVR 102 is shown in greater detail in FIG. 8. DVR 102 includes one or more microprocessors 802 (collectively referred to as CPU 802) that retrieve data and/or instructions from memory 804 and execute retrieved instructions in a conventional manner. Memory 804 can include generally any computer-readable medium including, for example, persistent memory such as magnetic and/or optical disks, ROM, and PROM and volatile memory such as RAM.

CPU 802 and memory 804 are connected to one another through a conventional interconnect 806, which is a bus in this illustrative embodiment and which connects CPU 802 and memory 804 to one or more input devices 808, output devices 810, and network access circuitry 812. Input devices 808 can include, for example, an infrared or radio frequency remote control and a number of push buttons. Output devices 810 can include, for example, a television such as television 120 (FIG. 1). Network access circuitry 812 (FIG. 8) sends and receives data through computer networks such as LAN 104 (FIG. 1).

A number of components of DVR 102 are stored in memory 804. In particular, audiovisual content recording logic 820 and audiovisual content playback logic 822 are each all or part of one or more computer processes executing within CPU 802 from memory 804 in this illustrative embodiment but can also be implemented using digital logic circuitry. As used herein, “logic” refers to (i) logic implemented as computer instructions and/or data within one or more computer processes and/or (ii) logic implemented in electronic circuitry.

Recorded content 400 and commercial log 700 are data stored persistently in memory 804 and can each be implemented as all or part of one or more databases.

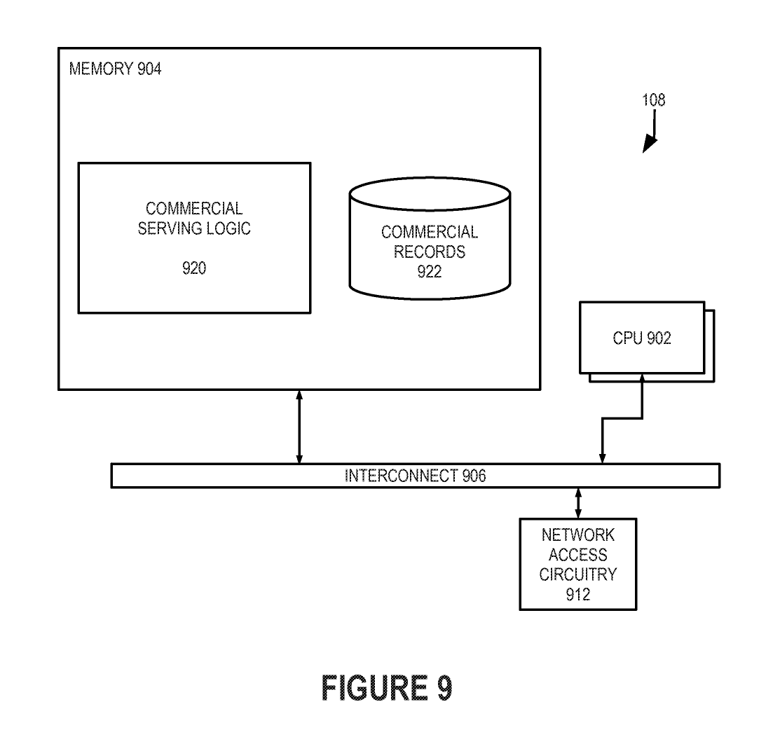

Commercial server 108 is shown in greater detail in FIG. 9. Commercial server 108 includes one or more microprocessors 902 (collectively referred to as CPU 902), memory 904, an interconnect 906, and network access circuitry 912 that are directly analogous to CPU 802 (FIG. 8), memory 804, interconnect 806, and network access circuitry 812, respectively.

A number of components of commercial server 108 (FIG. 9) are stored in memory 904. In particular, commercial serving logic 920 is all or part of one or more computer processes executing within CPU 902 from memory 904 in this illustrative embodiment but can also be implemented using digital logic circuitry.

Commercial records 922 are data stored persistently in memory 904 and can be implemented as all or part of one or more databases. Commercial records 922 stores commercial records such as commercial record 200 (FIG. 2) and commercial logs such as commercial log 700 (FIG. 7).

Commercial serving logic 920 (FIG. 9) receives requests for commercials and, in response thereto, sends commercials for playback in the manner described above. In addition, commercial serving logic 920 receives and stores commercial logs such as commercial log 700 (FIG. 7) in commercial records 922 (FIG. 9). As a result, commercial serving logic 920 has a complete and accurate count of impressions of all commercials played through DVR 102 and other devices that track playback of commercials in the manner described above.

Moreover, commercial serving logic 920 can use commercial logs to determine whether to substitute a commercial for a different, requested one. For example, commercial serving logic 920 can substitute a newer or different commercial for one that is requested by DVR 102 and that is shown in commercial log 700 (FIG. 7) for DVR 102 to be nearly always skipped.

The invention disclosed thus far has illustrated an embodiment in which digital content is provided primarily by means of satellite signals transmitting to a DVR device 102. The invention, however, is not limited to satellite communication systems, and can also be applied to any other system, such as cable television systems, that transmit video signals to the consumer.

For example, in another embodiment, the playback device 102 may comprise a media player for disk formats such as compact disk (CD), digital video disk (DVD), or blu-ray disk (BD), in which case the satellite dish 122 shown in FIG. 1 is not necessary. In this embodiment, the playback device 102 would connect to LAN 104 as previously described in the context of system 100. The content of the CD, DVD, or BD would include commercial records 200 and operate in the same manner as described above, so that during playback, time intervals reserved for commercials are filled with advertising content provided by a streaming server 108, in response to playback device 102 reading a URL and requesting from server 108 the advertising content associated with the URL. This embodiment is particularly useful, for example, to provide current advertising for the film industry. When viewing movies months or years after their release in disk format, consumers can be impressed with previews that advertise movies that are currently being released in theaters, rather than presenting previews for movies that are no longer current.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for tracking playback of commercials embedded in locally recorded audiovisual content, the method comprising:
playing the locally recorded audiovisual content;
detecting a commercial embedded in the locally recorded audiovisual content at a location;
retrieving a remotely located commercial that includes commercial audiovisual content;
playing the commercial audiovisual content in the locally recorded audiovisual content at the location during the playing of the locally recorded audiovisual content;
determining whether the entirety of the commercial audiovisual content is played back at a normal rate; and
logging the playing of the commercial audiovisual content and whether the entirety of the commercial audiovisual content is played back at a normal rate.

2. The method of claim 1 further comprising:
capturing a received audiovisual signal to form the locally recorded audiovisual content;
detecting the commercial in the locally recorded audiovisual content at the location; and
storing an identifier of the commercial in association with the location;
wherein the retrieving a remotely located commercial includes sending the identifier of the commercial to a remotely located commercial server.

3. The method of claim 2 wherein meta data in the received audiovisual signal identifies the commercial.

4. The method of claim 1 wherein the retrieving a remotely located commercial comprises:
sending an identifier of the commercial to a remotely located commercial server.

5. The method of claim 1 further comprising:
sending log data that represents the playing of the commercial audiovisual content and whether the entirety of the commercial audiovisual content is played back at a normal rate to a remotely located commercial server.

6. A tangible computer readable medium useful in association with a device which includes one or more processors and a memory, the computer readable medium including computer instructions which are conFIG.d to cause the device, by execution of the computer instructions in the one or more processors from the memory, to track playback of commercials embedded in locally recorded audiovisual content by at least:
playing the locally recorded audiovisual content;
detecting a commercial embedded in the locally recorded audiovisual content at a location;
retrieving a remotely located commercial that includes commercial audiovisual content;
playing the commercial audiovisual content in the locally recorded audiovisual content at the location during the playing of the locally recorded audiovisual content;
determining whether the entirety of the commercial audiovisual content is played back at a normal rate; and
logging the playing of the commercial audiovisual content and whether the entirety of the commercial audiovisual content is played back at a normal rate.

7. The computer readable medium of claim 6 wherein the computer instructions are conFIG.d to cause the device to track playback of commercials embedded in locally recorded audiovisual content by at least also:
capturing a received audiovisual signal to form the locally recorded audiovisual content;
detecting the commercial in the locally recorded audiovisual content at the location; and
storing an identifier of the commercial in association with the location;
wherein the retrieving a remotely located commercial includes sending the identifier of the commercial to a remotely located commercial server.

8. The computer readable medium of claim 7 wherein meta data in the received audiovisual signal identifies the commercial.

9. The computer readable medium of claim 6 wherein the retrieving a remotely located commercial comprises:
sending an identifier of the commercial to a remotely located commercial server.

10. The computer readable medium of claim 6 wherein the computer instructions are conFIG.d to cause the device to track playback of commercials embedded in locally recorded audiovisual content by at least also:
sending log data that represents the playing of the commercial audiovisual content and whether the entirety of the commercial audiovisual content is played back at a normal rate to a remotely located commercial server.

11. A device comprising:
at least one processor;
a computer readable medium that is operatively coupled to the processor;
network access circuitry that is operatively coupled to the processor; and
commercial tracking logic (i) that executes at least in part in the processor from the computer readable medium and (ii) that, when executed, causes the device to track playback of commercials embedded in locally recorded audiovisual content by at least:
playing the locally recorded audiovisual content;
detecting a commercial embedded in the locally recorded audiovisual content at a location;
retrieving a remotely located commercial that includes commercial audiovisual content;
playing the commercial audiovisual content in the locally recorded audiovisual content at the location during the playing of the locally recorded audiovisual content;
determining whether the entirety of the commercial audiovisual content is played back at a normal rate; and
logging the playing of the commercial audiovisual content and whether the entirety of the commercial audiovisual content is played back at a normal rate.

12. The device of claim 11 wherein the commercial tracking logic causes the device to track playback of commercials embedded in locally recorded audiovisual content by at least also:
capturing a received audiovisual signal to form the locally recorded audiovisual content;
detecting the commercial in the locally recorded audiovisual content at the location; and
storing an identifier of the commercial in association with the location;
wherein the retrieving a remotely located commercial includes sending the identifier of the commercial to a remotely located commercial server.

13. The device of claim 12 wherein meta data in the received audiovisual signal identifies the commercial.

14. The device of claim 11 wherein the retrieving a remotely located commercial comprises:
sending an identifier of the commercial to a remotely located commercial server.

15. The device of claim 11 wherein the commercial tracking logic causes the device to track playback of commercials embedded in locally recorded audiovisual content by at least also:
sending log data that represents the playing of the commercial audiovisual content and whether the entirety of the commercial audiovisual content is played back at a normal rate to a remotely located commercial server.
